(19) United States
(12) Patent Application Publication
(10) Pub. No.: US 2023/0245215 A1
(43) Pub. Date: Aug. 3, 2023

(54) SYSTEMS AND METHODS FOR GENERATING A FULFILLMENT INTENT DETERMINATION FOR AN EVENT

(71) Applicant: Walmart Apollo, LLC, Bentonville, AR (US)

(72) Inventors: Sooraj Mangalath Subrahmannian, San Jose, CA (US); Parth Ramesh Vajge, Sunnyvale, CA (US); Spencer Galbraith, Bella Vista, AR (US); Yue Xu, San Francisco, CA (US); Divya Chaganti, San Jose, CA (US); Hyun Duk Cho, San Francisco, CA (US); Sushant Kumar, San Jose, CA (US); Kannan Achan, Saratoga, CA (US)

(21) Appl. No.: 17/587,779

(22) Filed: Jan. 28, 2022

(51) Int. Cl. G06Q 30/06

(52) U.S. Cl. CPC G06Q 30/0639; G06Q 30/0629

(57) ABSTRACT

A fulfillment intent system can include a computing device configured to receive an indication of an event occurring from a user device and obtain a set of historical data associated with a user identifier indicated by the user device. The computing device is further configured to determine a fulfillment parameter by applying a machine learning model to the set of historical data and obtain a set of item identifiers based on the indication. The computing device is also configured to organize the set of item identifiers based on the fulfillment parameter and transmit the set of item identifiers to the user device for display on a user interface of the user device.

### TECHNICAL FIELD

The disclosure relates generally to systems and methods for generating fulfillment intent determinations and more particularly to determining a present fulfillment intent based on historical database entries.

### BACKGROUND

Customers shop for a variety of different items on ecommerce platforms. For example, customers can select a variety of different fulfillment options to receive their items. Fulfillment options include delivery, in-store pickup, shopping in-store, and the same options through a fulfillment center.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The embodiments described herein are directed to a fulfillment intent system and related methods. The fulfillment intent system can include a computing device that is configured to receive an indication of an event occurring from a user device and obtain a set of historical data associated with a user identifier indicated by the user device. The computing device is further configured to determine a fulfillment parameter by applying a machine learning model to the set of historical data and obtain a set of item identifiers based on the indication. The computing device is also configured to organize the set of item identifiers based on the fulfillment parameter and transmit the set of item identifiers to the user device for display on a user interface of the user device.

In another aspect, the indication is a query submitted on the user device.

In another aspect, the set of historical data includes, for the user identifier, items previously purchased, previous add to cart item selections, and previous item views.

In another aspect, the set of historical data includes for each item indicated, a historical fulfillment type of the item and a consideration intent of the item.

In another aspect, organizing the set of item identifiers based on the fulfillment parameter includes prioritizing items associated with the fulfillment parameter.

In another aspect, the computing device is configured to store the fulfillment parameter in a historical database.

In another aspect, the computing device is configured to compute a likelihood of a fulfillment preference for a set of fulfillment parameters and select the fulfillment parameter corresponding to the highest likelihood.

In various embodiments of the present disclosure, a method of fulfillment intents is provided. In some embodiments, the method can include receiving an indication of an event occurring from a user device and obtaining a set of historical data associated with a user identifier indicated by the user device. The method also includes determining a fulfillment parameter by applying a machine learning model to the set of historical data and obtaining a set of item identifiers based on the indication. The method further includes organizing the set of item identifiers based on the fulfillment parameter and transmitting the set of item identifiers to the user device for display on a user interface of the user device.

In various embodiments of the present disclosure, a non-transitory computer readable medium is provided. The non-transitory computer readable medium can have instructions stored thereon, wherein the instructions, when executed by at least one processor, cause a device to perform operations that include receiving an indication of an event occurring from a user device and obtaining a set of historical data associated with a user identifier indicated by the user device. The operations also include determining a fulfillment parameter by applying a machine learning model to the set of historical data and obtaining a set of item identifiers based on the indication. The operations further include organizing the set of item identifiers based on the fulfillment parameter and transmitting the set of item identifiers to the user device for display on a user interface of the user device.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The features and advantages of the present disclosures will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 is a block diagram of a fulfillment intent system in accordance with some embodiments;

FIG. 2 is a block diagram of a computing device implementing the fulfillment intent device of FIG. 1 in accordance with some embodiments;

FIG. 3 is a block diagram illustrating an example fulfillment intent module of the fulfillment intent system of FIG. 1 in accordance with some embodiments;

FIG. 4 is a block diagram illustrating an example search implementation module of the fulfillment intent system of FIG. 1 in accordance with some embodiments;

FIG. 5 is a flowchart of example methods of methods of predicting fulfillment type for a shopping event in accordance with some embodiments; and

FIG. 6 is a flowchart of examples methods of generating and transmitting an organized set of item to a user device in accordance with some embodiments.

In the drawings, reference numbers may be reused to identify similar and/or identical elements.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “connected,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

A fulfillment intent system may be implemented to determine a predicted fulfillment intent of a present shopping event and re-order or re-rank recommended items displayed to a customer or user. For example, absent an explicit fulfillment intent indicator, such as the customer booking a pick up slot, filtering items based on fulfillment type, etc., the fulfillment intent system determines a predicted fulfillment type and organizes search results or recommended items according to customer's predicted fulfillment type. A user shopping on an ecommerce website may have a variety of fulfillment options, including in-store delivery, in-store pickup, fulfillment center delivery, and fulfillment center pickup. Additionally, the delivery fulfillment types may vary based on delivery time or date, for example, for in-store delivery, the user may book a particular time slot on that day to have items delivered, which provides an explicit intent of which fulfillment type the user desires. Therefore, the fulfillment intent system can automatically rank those items higher that correspond to the indicated fulfillment type, displaying those items to the user at the top of the results page.

The fulfillment intent system reorganizes the items displayed to the user based on the predicted fulfillment type to improve user experience and ease of finding items that align with the present fulfillment type for their order. For example, the fulfillment intent system may assist a user in avoiding a split basket (that is, an order including multiple different fulfillment types, which can add unnecessary logistical complexity) and in finding items that adhere to their fulfillment type more easily. The fulfillment intent system implements a machine learning algorithm to predict the fulfillment type of a particular order during a shopping event (when the user is searching for items on the ecommerce website and adding items to their cart). The machine learning algorithm may implement a Bayesian model and/or Markov chain models to determine which fulfillment type is most likely.

The Bayesian model may estimate a likelihood of each of the different fulfillment types based on historical data including the user's historical transactions, the user's historical add to cart selections, the user's historical view selections, an item's historical fulfillment type, and an item's consideration intent (that is, whether the items the user is presently viewing or in their cart requires a high level of consideration prior to purchase or a low about of consideration prior to purchase). The Markov chain model may also be implemented to predict a probability of a particular fulfillment type based on the user's previous fulfillment type for a previous transaction, using the same historical data listed above. The fulfillment intent system may implement an ensemble of a Bayesian model and a Markov chain model to predict fulfillment type for each order when the user has not explicitly indicated. Based on the predicted fulfillment type, the fulfillment intent system may organize or re-order items displayed to the user when the user is searching during the shopping event.

The fulfillment intent system may train the machine learning model on a daily basis, updating the model with the transactions that occurred throughout the day. As listed above, the machine learning model is trained using historical transactions, previous fulfillment types of items, and consideration intent for items. When a user submits a query to search for items during the shopping event, the fulfillment intent system can re-order the items returned to ensure those items that provide the predicted fulfillment type are displayed at the beginning of the list. In various implementations, the fulfillment intent system also organizes by a number of days for delivery to match the number of days to deliver the items in the user's cart.

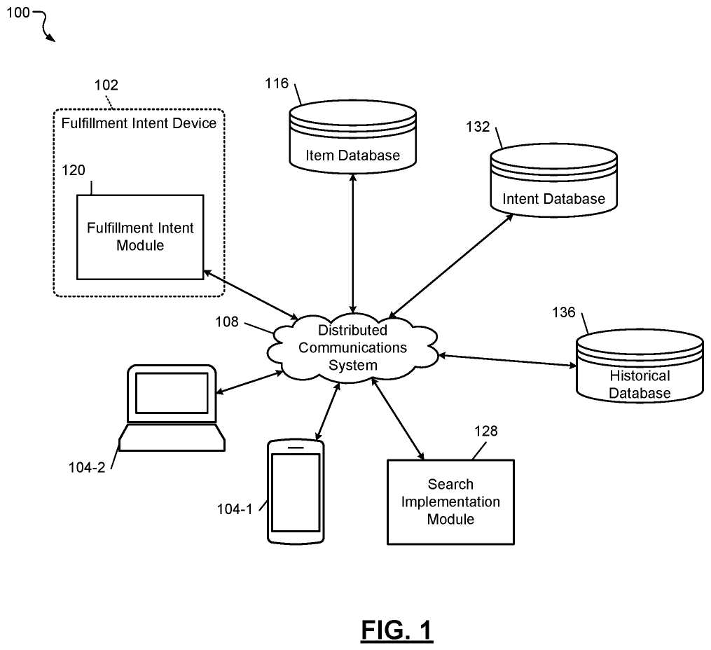

Referring to FIG. 1, a block diagram of a fulfillment intent system 100 is shown. The fulfillment intent system 100 may include a fulfillment intent device 102 and user devices 104-1 and 104-2, collectively user device 104, such as a phone, tablet, laptop, mobile computing device, desktop, etc., capable of communicating with a plurality of databases and modules via a distributed communications system 108. The user device 104 may display an ecommerce marketplace via a web browser or an application for customers to view items for sale by the ecommerce marketplace that are stored in an item database 116. For example, a customer may browse a webpage being display on a graphical user interface of the user device 104 and/or submit a query through the graphical user interface of the user device 104 on the ecommerce marketplace through a web browser or application, which retrieves a subset of items from the item database 116 that pertain to the query and displays the subset of items to the customer via the graphical user interface of the user device 104.

The fulfillment intent system 100 also includes a fulfillment intent module 120 and a search implementation module 124. The fulfillment intent module 120 obtains historical data from the item database, an intent database 132 and a historical database 136 that characterize the user's previous shopping events and the items the user is viewing during the present shopping event. The historical data is collected in response to the fulfillment intent device 102 receiving real time signals from the user's shopping event, such as search queries, adding items to a cart, etc. Since the fulfillment intent device 102 is based on the users past behavior, the user may be using the ecommerce website or an application on the user device 104 and is logged into a corresponding account. Based on the user indicated in the account information, the fulfillment intent module 120 can obtain historical data related to that user.

The fulfillment intent module 120 then applies a machine learning algorithm, as discussed above, to the obtained data to determine a predicted fulfillment type. For example, the fulfillment intent module 120 may categorize the particular shopping event as being fulfilled by in-store delivery, in-store pickup, fulfillment center delivery, or fulfillment center pickup. Once categorized, the search implementation module 128 can reorganize the items returned to the user based on the fulfillment type category. For example, the fulfillment intent module 120 may store the category in the historical database 136, which can be used to train the machine learning model, and/or transmit the category to the search implementation module 128. The fulfillment intent module 120 may continuously update the fulfillment type category throughout the shopping event and the search implementation module 128 can return ordered search results according to the newest categorization. Alternatively, the fulfillment type may be predicted within a threshold period of the shopping event occurring and remain the same throughout the shopping event.

The item database 116 includes identifiers for each item offered for sale on the ecommerce website as well as corresponding historical fulfillment types for each of items. The intent database 132 stores a consideration intent corresponding to each of the items, indicating whether the item is a high consideration item or a low consideration item, as described above. In various implementations, the consideration intent may be a numerical value.

The fulfillment intent device 102 and the user device 104 can be any suitable computing device that includes any hardware or hardware and software combination for processing and handling information. For example, the term “device” and/or “module” can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, the distributed communications system 108. In various implementations, the devices, modules, and databases may communicate directly on an internal network.

As indicated above, the fulfillment intent device 102 and/or the user device 104 can be a computer, a workstation, a laptop, a server such as a cloud-based server, or any other suitable device. In some examples, fulfillment intent device 102 and/or the user device 104 can be a cellular phone, a smart phone, a tablet, a personal assistant device, a voice assistant device, a digital assistant, a laptop, a computer, or any other suitable device. In various implementations, the fulfillment intent device 102 is on a central computing system that is operated and/or controlled by a retailer. Additionally or alternatively, the modules and databases of the fulfillment intent device 102 are distributed among one or more workstations or servers that are coupled together over the distributed communications system 108.

The databases described can be remote storage devices, such as a cloud-based server, a memory device on another application server, a networked computer, or any other suitable remote storage. Further, in some examples, the databases can be a local storage device, such as a hard drive, a non-volatile memory, or a USB stick.

The distributed communications system 108 can be a WiFix network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The distributed communications system 108 can provide access to, for example, the Internet.

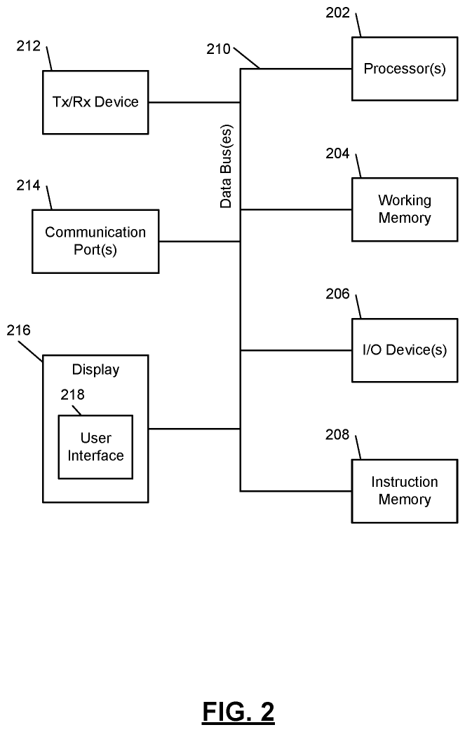

FIG. 2 illustrates an example computing device 200. The fulfillment intent device 102 and/or the user device 104 may include the features shown in FIG. 2. For the sake of brevity, FIG. 2 is described relative to the fulfillment intent device 102.

As shown, the fulfillment intent device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of the fulfillment intent device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as data items including feedback information.

Display 216 can display a user interface 218. User interfaces 218 can enable user interaction with the fulfillment intent device 102. For example, user interface 218 can be a user interface that allows an operator to select and browse items via the ecommerce website or marketplace. The user interface 218 can, for example, display the items for sale for a user or customer view as a result of searching or browsing on an ecommerce website or marketplace. In some examples, display 216 can be a touchscreen, where user interface 218 is displayed on the touchscreen.

Transceiver 212 allows for communication with a network, such as the distributed communications system 108 of FIG. 1. For example, if the distributed communications system 108 of FIG. 1 is a cellular network, transceiver 212 is configured to allow communications with the cellular network. In some examples, transceiver 212 is selected based on the type of distributed communications system 108 in which the fulfillment intent device 102 will be operating. Processor(s) 202 is operable to receive data from, or send data to, a network, such as the distributed communications system 108 of FIG. 1, via transceiver 212.

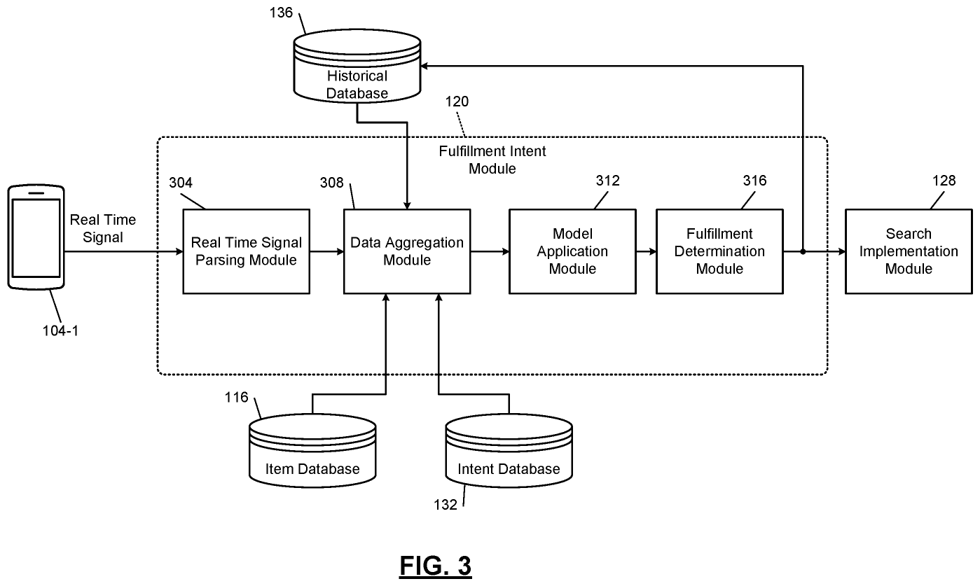

Referring now to FIG. 3, a block diagram illustrating an example fulfillment intent module 120 of the fulfillment intent system 100 is shown. The fulfillment intent module 120 includes a real time signal parsing module 304 that receives real time signals from the user device 104 that is being used to conduct a shopping event. The real time signals include selections made by the user on the user device 104 as well as login information, item views, add to cart selections, etc. The real time signal parsing module 304 parses the real time signals to identify a user and selections being made, indicating which items the user is viewing and those items that are being added to a cart. The real time signal parsing module 304 forwards the identified user and items relevant to the present shopping event to a data aggregation module 308.

The data aggregation module 308 obtains historical data related to the user from the historical database 136, including previous transactions, previous items that were added to a cart, and previous items that the user viewed. Additionally, the data aggregation module 308 obtains historical fulfillment for items identified during previous shopping events and items that customer is presently viewing/adding to their cart. That is, whether the item is typically picked up in-store, delivered, etc. the data aggregation module 308 also obtains item consideration intent for those identified items, indicating whether they are more frequently associated with a high consideration shopping event or a low consideration shopping event. The aggregated data is forwarded to a model application module 312. The model application module 312 implements a machine learning algorithm to determine a predicted fulfillment type based on the aggregated data. As described above, the model application module 312 may implement an ensemble of a Bayesian model and a one step Markov chain model to predict the most likely fulfillment type. In various implementations, a likelihood score may be determined by the machine learning algorithm for each of the fulfillment types. Additionally or alternatively, the machine learning algorithm may categorize the shopping event.

The predicted likelihood scores for each fulfillment type may be forwarded to a fulfillment determination module 316 that identifies which fulfillment type has the highest likelihood. In various implementations, particular threshold for each fulfillment type may be identified and a fulfillment type may only be selected if the predicted likelihood exceed the threshold. The fulfillment determination module 316 stores the predicted fulfillment type in the historical database 136 and may also forward the fulfillment type to the search implementation module 128.

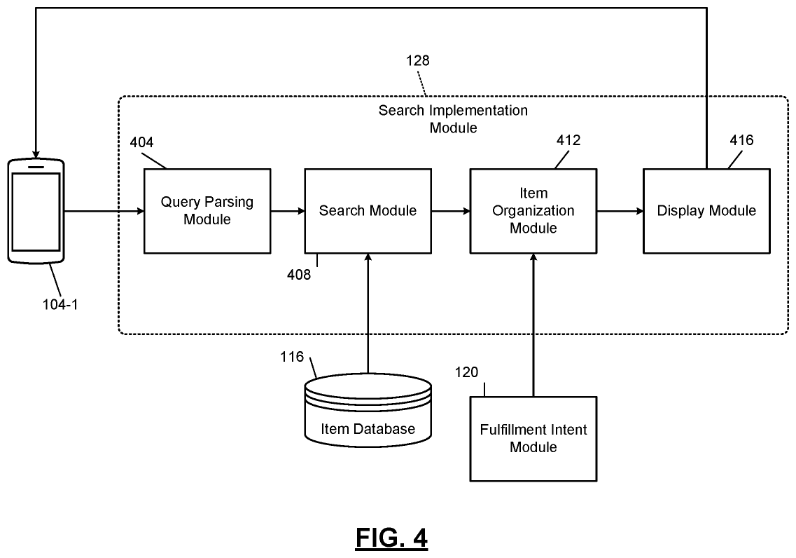

Referring now to FIG. 4, a block diagram illustrating an example search implementation module 128 of the fulfillment intent system 100 is shown. The search implementation module 128 includes a query parsing module 404 that receives a query from a user device 104. For example, the user enters a search query for the items the user wants to purchase. The query parsing module 404 analyzes the query to identify salient search terms, removing stop words, etc. and forwards the search terms to a search module 408. The search module 408 identifies a set of items in the item database 116 that are considered salient to the search terms or include the search terms. The set of items is forwarded to an item organization module 412. The item organization module 412 receives the predicted fulfillment type for the fulfillment intent module 120. In various implementations, the item organization module 412 may obtain the predicted fulfillment type from the historical database 136. The item organization module 412 re-orders the set of items to place those items that align with the predicted fulfillment type to the top of the search results displayed to the user on the user device 104. The organization items are forwarded to a display module 416 that generates and displays the organized set of items on a user interface of the user device.

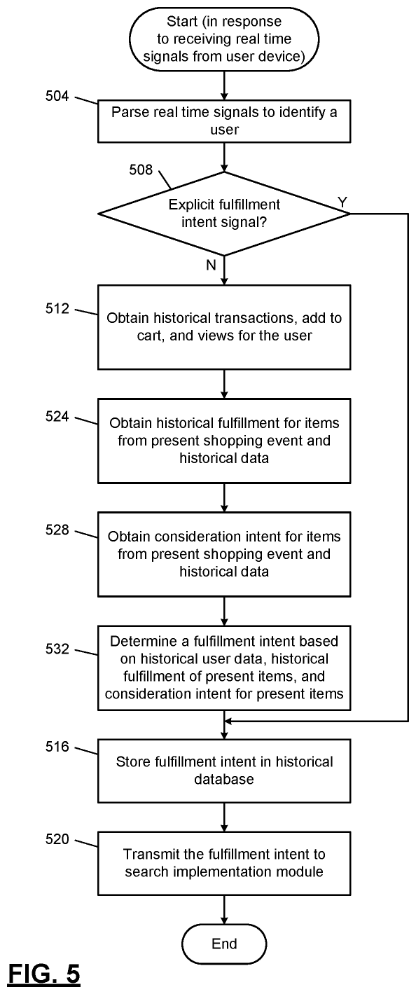

Referring now to FIG. 5, a flowchart of example methods of predicting fulfillment type for a shopping event is shown. Control begins in response to receiving real time signals from a user device. Control proceeds to 504 to parse the real time signals to identify a user. At 508, control determines if any explicit fulfillment intent indicating the fulfillment type is included in the signals, such as reserving a time slot for delivery or pickup. If no, control proceeds to 512 to obtain historical data for the user, including transactions, adding an item to a cart, and item views. Otherwise, if the real time signals include explicit fulfillment intent, control continues to 516 to store the fulfillment intent in the historical database. Then, control proceeds to 520 to transmit the fulfillment intent to the search implementation module and control ends.

Returning to 512, control proceeds to 524 to obtain historical fulfillment for items from the present shopping event and the historical data. Control proceeds to 528 to obtain consideration intent for the items from the present shopping event and historical data. Control continues to 532 to determine a fulfillment intent based on the obtained historical user data, historical fulfillment of present and past items, and consideration intent for present and past items. Then, control continues to 516 to store the fulfillment intent in the historical database.

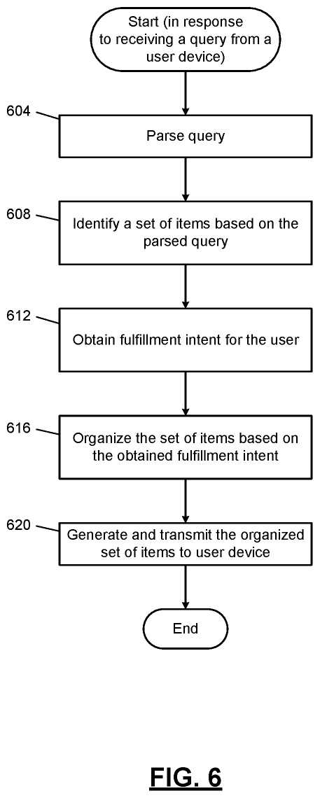

Referring now to FIG. 6, a flowchart of examples methods of generating and transmitting an organized set of item to a user device is shown. Control begins in response to a receiving a query from a user device. In various implementations, the query could be in the form of a user selection, such as navigating to a particular webpage. Once the query is received, control continues to 604 to parse the query. For example, parse any user input, such as search terms or the user selecting a subset of items by navigating to a particular webpage. At 608, control identifies a set of items based on the parsed query. Control proceeds to 612 to obtain fulfillment intent/type for the user. As shown in FIG. 5, the fulfillment intent may be directly forwarded to the search implementation module and/or stored in a database. Control proceeds to 616 to organize the set of items based on the obtained fulfillment intent. As mentioned previously, the set of items is organized to have the items that align with the fulfillment intent displayed to the user first, ahead of those items that are relevant, but have a different fulfillment type. Control continues to 620 to generate and transmit the organized set of items to the user device. Then, control ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning. Machine learning may involve training a model in a supervised or unsupervised setting. Machine learning can include models that may be trained to learn relationships between various groups of data. Machine learned models may be based on a set of algorithms that are designed to model abstractions in data by using a number of processing layers. The processing layers may be made up of non-linear transformations. The models may include, for example, artificial intelligence, neural networks, deep convolutional and recurrent neural networks. Such neural networks may be made of up of levels of trainable filters, transformations, projections, hashing, pooling and regularization. The models may be used in large-scale relationship-recognition tasks. The models can be created by using various open-source and proprietary machine learning tools known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

1. A system comprising:
a non-transitory memory having instructions stored thereon; and
a processor configured by the instructions to:
receive a plurality of real time signals including an indication of an event occurring from a user device;
obtain a set of historical data associated with a user identifier associated with the user device;
determine a fulfillment parameter by implementing a machine learning ensemble comprising at least one trained Bayesian model and at least one Markov chain model, wherein the set of historical data and a subset of the plurality of real time signals are provided as inputs to the machine learning ensemble model;
obtain a set of item identifiers based on the indication;
generate a set of ordered item identifiers based on the set of item identifiers and the fulfillment parameter;
transmit instructions for generating a user interface including the set of ordered item identifiers to the user device for display;
receive transaction data from the user device in response to displaying the user interface; and
train an updated machine learning ensemble including an updated Bayesian model, an updated Markov chain model, or a combination thereof, wherein the updated machine learning ensemble is generated based in part on the transaction data.

2. The system of claim 1, wherein the indication is a query submitted on the user device.

3. The system of claim 1, wherein the set of historical data includes, for the user identifier, items previously purchased, previous add to cart item selections, and previous item views.

4. The system of claim 3, wherein the set of historical data includes for each item indicated, a historical fulfillment type of the item and a consideration intent of the item.

5. The system of claim 1, wherein the set of ordered item identifiers prioritizes items associated with the fulfillment parameter.

6. The system of claim 1, wherein the processor is configured to store the fulfillment parameter in a historical database.

7. The system of claim 1, wherein the processor is configured to compute a likelihood of a fulfillment preference for a set of fulfillment parameters and select the fulfillment parameter corresponding to the highest likelihood.

8. A method comprising:
receiving a plurality of real time signals including an indication of an event occurring from a user device;
obtaining a set of historical data associated with a user identifier associated with the user device;
determining a fulfillment parameter by implementing a machine learning ensemble comprising at least one trained Bayesian model and at least one Markov chain model, wherein the set of historical data and a subset of the plurality of real time signals are provided as inputs to the machine learning ensemble model;
obtaining a set of item identifiers based on the indication;
generating a set of ordered item identifiers based on the set of item identifiers and the fulfillment parameter;
transmitting instructions for generating a user interface including the set of ordered item identifiers to the user device for display;
receiving transaction data from the user device in response to displaying the user interface; and
training an updated machine learning ensemble including an updated Bayesian model, an updated Markov chain model, or a combination thereof, wherein the updated machine learning ensemble is generated based in part on the transaction data.

9. The method of claim 8, wherein the indication is a query submitted on the user device.

10. The method of claim 8, wherein the set of historical data includes, for the user identifier, items previously purchased, previous add to cart item selections, and previous item views.

11. The method of claim 10, wherein the set of historical data includes for each item indicated, a historical fulfillment type of the item and a consideration intent of the item.

12. The method of claim 8, wherein the set of ordered item identifiers prioritizes items associated with the fulfillment parameter.

13. The method of claim 8, further comprising storing the fulfillment parameter in a historical database.

14. The method of claim 8, further comprising computing a likelihood of a fulfillment preference for a set of fulfillment parameters and selecting the fulfillment parameter corresponding to the highest likelihood.

15. A non-transitory computer-readable medium having instructions stored thereon, wherein the instructions, when executed by at least one processor, cause a device to perform operations comprising:
receiving a plurality of real time signals including an indication of an event occurring from a user device;
obtaining a set of historical data associated with a user identifier associated with the user device;
determining a fulfillment parameter by implementing a machine learning ensemble comprising at least one trained Bayesian model and at least one Markov chain model, wherein the set of historical data and a subset of the plurality of real time signals are provided as inputs to the machine learning ensemble model;
obtaining a set of item identifiers based on the indication;
generating a set of ordered item identifiers based on the set of item identifiers and the fulfillment parameter;
transmitting instructions for generating a user interface including the set of ordered item identifiers to the user device for display;
receiving transaction data from the user device in response to displaying the user interface; and
training an updated machine learning ensemble including an updated Bayesian model, an updated Markov chain model, or a combination thereof, wherein the updated machine learning ensemble is generated based in part on the transaction data.

16. The non-transitory computer-readable medium of claim 15, wherein the indication is a query submitted on the user device.

17. The non-transitory computer-readable medium of claim 15, wherein the set of historical data includes, for the user identifier, items previously purchased, previous add to cart item selections, and previous item views.

18. The non-transitory computer-readable medium of claim 17, wherein the set of historical data includes for each item indicated, a historical fulfillment type of the item and a consideration intent of the item.

19. The non-transitory computer-readable medium of claim 15, wherein the set of ordered item identifiers prioritizes items associated with the fulfillment parameter.

20. The non-transitory computer-readable medium of claim 15, further comprising storing the fulfillment parameter in a historical database.
